(19) United States
(12) Patent Application Publication
(10) Pub. No.: US 2010/0240842 A1
(43) Pub. Date: Sep. 23, 2010

(54) Polyhydroxy-Functional Polysiloxanes, method for the production and use thereof

(75) Inventors: Albert Frank, Xanten (DE); Wolfgang Griesel, Hamminkeln (DE); Petra D. Valentina, Dinslaken (DE); Michaela Vorderwulbeke, Rees (DE)

Correspondence Address: SCHWEGMAN, LUNDBERG & WOESSNER, P.A., P.O. BOX 2938, MINNEAPOLIS, MN, 55402, US

(73) Assignee: BYK-Chemie GmbH, Wesel (DE)

(21) Appl. No.: 12/308,597

(22) PCT Filed: Jul. 4, 2007
(86) PCT No.: PCT/EP2007/005895

§ 371 Date: Feb. 24, 2009

(30) Foreign Application Priority Data
Jul. 4, 2006 (DE) 102006031152.3

(51) Int. Cl. C08F 283/12

(52) U.S. Cl. 525/479

(57) ABSTRACT

The invention relates to polyhydroxy-functional polysiloxanes which are preparable by the addition reaction of at least one branched polyhydroxy-functional allyl polyether with an Si—H-functional alkyl polysiloxane, to processes for preparing them, to their use as additives in coating compositions, polymeric moulding compounds or thermoplastics, and to coating compositions, polymeric moulding compounds and thermoplastics that comprise them.

The present invention relates to polyhydroxy-functional polysiloxanes which can be prepared by the addition reaction of polyhydroxy-functional allyl polyethers with alkylhydrosiloxanes.

It is known to add polysiloxanes to coatings and polymeric moulding compounds in order to achieve certain qualities, for example improved scratch resistance or improved levelling in the case of furniture varnishes and vehicle finishes. Use of the polysiloxanes is widespread and very diverse.

Polyhydroxy-functional polysiloxanes are known in principle from numerous patent specifications.

U.S. Pat. No. 3,381,019 describes the preparation of siloxane-alcohol ethers by the reaction of polyhydroxy-functional allyl compounds with Si—H-functional polysiloxanes. The resulting compounds are described as foam stabilizers and as defoamers for aqueous systems.

U.S. Pat. No. 4,640,940 describes the preparation of polyol-terminated silicones and the use of these compounds with free OH groups, or their derivatives, in curable compositions, including radiation-curable compositions.

U.S. Pat. No. 4,431,789 describes the preparation of organosiloxanes with alcoholic hydroxyl groups. The compounds are prepared by the hydrosilylation of methylhydrosiloxanes and polyglyercols which have a terminal allyl group. The compounds obtained in this way can be used as nonionic surface-active poly-siloxanes.

JP 10316540 describes reaction products of methylhydrosiloxanes and allyl polyglycerols, very similar to those in U.S. Pat. No. 4,431,789, as hair-conditioning agents.

U.S. Pat. No. 5,916,992 and U.S. Pat. No. 5,939,491 describe polysiloxane polyols having primary OH groups and also curable coatings which comprise these polysiloxane polyols.

These coatings are said to feature improved adhesion, scratch resistance and high gloss.

The object of the present invention was to improve the properties of coating compositions, polymeric moulding compounds and thermoplastics. More particularly the object was to provide coating compositions, polymeric moulding compounds and thermoplastics which display an improved anti-adhesive and/or dirt-repellent action. Furthermore, the additives added in order to impart these improved properties ought as far as possible not to detract from the other properties of the coating compositions, polymeric moulding compounds or thermoplastics. The additives added ought also to be able to develop their activity in relatively low amounts. The coating compositions, polymeric moulding compounds and thermoplastics ought, furthermore, to virtually retain their anti-adhesive and/or dirt-repellent action over a long time period, of several years, even under outdoor weathering conditions. This retention of properties ought also to include the permanence of the anti-adhesive and/or dirt-repellent effect over a plurality of cleaning cycles.

Surprisingly it has emerged that the objects described above are achieved by means of polyhydroxy-functional polysiloxanes which can be prepared by the addition reaction of at least one branched polyhydroxy-functional allyl polyether with an Si—H-functional alkylpolysiloxane. Coating compositions, polymeric moulding compounds or thermoplastics to which these addition products are added exhibit excellent anti-adhesive and dirt-repellent properties. The addition products of the invention also do not substantially detract from the other properties of the coating compositions, polymeric moulding compounds or thermoplastics. These polyhydroxy-functional polysiloxanes can be added in relatively low amounts (additive amounts), to the coating compositions or polymeric moulding compounds. The physical properties of the original coating compositions, polymeric moulding compounds and thermoplastics, in respect, for example, of corrosion control, gloss retention and weathering stability, are unaffected by the low concentrations of the additive. Coating compositions, polymeric moulding compounds and thermoplastics which comprise the addition products of the invention generally also display the desired properties over a time period of several years, and also retain these properties over a plurality of cleaning cycles.

The polyhydroxy-functional polysiloxane of the invention that can be added to coating compositions, polymeric moulding compounds and thermoplastics is preparable via the addition reaction of at least one branched polyhydroxy-functional allyl polyether with an Si—H-functional polysiloxane. The expression “branched polyether” in this context stands for a polyether in which the main chain and at least one side chain contain polyether bridges. Preferably the at least one branched polyether has a dendritic structure.

The Si—H-functional polysiloxane can be a chain polymer, a cyclic polymer, a branched polymer or a crosslinked polymer. Preferably it is a chain polymer or a branched polymer. With particular preference it is a chain polymer. The Si—H-functional alkylpolysiloxane is preferably an alkylhydropolysiloxane substituted by corresponding C₁-C₁₄ alkylene, arylene or aralkylenes. Preferably the alkylhydropolysiloxane is a methylhydro-polysiloxane.

Preferred subject matter of the invention are polyhydroxy-functional chain-like polysiloxanes which can be represented by the following general formula (I):

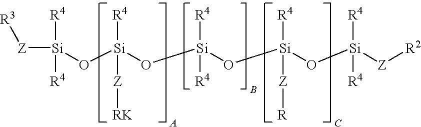

where
Z=C₁-C₁₄ alkylene,
RK=unbranched polyether radical composed of alkylene oxide units having 1-6 carbon atoms, and/or aliphatic and/or cycloaliphatic and/or aromatic polyester radical having a weight-average molecular weight of between 200 and 4000 g/mol,
R=polyhydroxy-functional branched polyether radical,
R² and R³ independently of one another are C₁-C₁₄ alkyl aryl or aralkyl, —O(C₁-C₁₄ alkyl, aryl or aralkyl), —OCO(C₁-C₁₄ alkyl, aryl or aralkyl), —O—CO—O(C₁-C₁₄ alkyl, aryl or aralkyl), —OSO₂(C₁-C₁₄ alkyl, aryl or aralkyl), —H, —Cl, —F, —OH, —R, —RK,
R⁴=C₁-C₁₄ alkyl, aryl or aralkyl,
A=0-20, preferably 0-15, more preferably 0-8,
B=2-300, preferably 10-200, more preferably 15-100 and
C=0-20, preferably 0-15, more preferably 0-8;
   and if C=0 then R³=R and/or R²=R.

If the unit —[SiR⁴(Z—R)]—O— is present, i.e. C is at least 1, then it is possible for R² and R³ to be different from R.

Compounds of the general formula (I) in which A is at least 1 are advantageously used in those systems which require a compatibility adaptation.

The copolymers corresponding to the structural formula indicated above may be random copolymers, alternating copolymers or block copolymers. In addition, a gradient may be formed by the sequence of the side chains along the silicone backbone. In other words, the A units of the formula —[SiR⁴(Z—RK)]—O—, the B units —Si(R⁴)₂—O— and the C units —[SiR⁴(Z—R)]—O— may be arranged in any order in the polysiloxane chain.

As may be concluded from the structure of the formula (I) and from the corresponding definitions for A, B and C₁ the chain-like polyhydroxy-functional polysiloxanes of the invention are composed of 4 to 342 siloxane units. Preferably the chain-like polyhydroxy-functional polysiloxanes of the invention are composed of 10 to 100 siloxane units, more preferably of 20 to 80 siloxane units, with particular preference of 30 to 70 siloxane units.

In order to incorporate the polyhydroxy-functional branched polyether alkyl radical —Z—R into the Si—H-functional polysiloxane, it is preferred to use polyhydroxy-functional dendritic allyl polyethers which can be prepared by ring-opening polymerization of hydroxyoxetanes, i.e. compounds having an oxetane group and at least one hydroxyl group or hydroxyalkyl group, with one or more hydroxy-bearing allylic starter compounds. These branched polyhydroxy-functional allyl polyethers can be introduced into the polysiloxane by addition reaction.

Alternatively the polyhydroxy-functional branched polyetheralkyl radical —Z—R can be introduced into the polysiloxane by condensation reaction of a dendritic polyhydroxy-functional hydroxyalkyl polyether. The hydroxyalkyl polyether can be prepared by ring-opening polymerization of hydroxyoxetanes with one or more hydroxyl-bearing allylic starter compounds and subsequent addition reaction of water.

These allylic starter compounds may, like allyl alcohol, for example, be monofunctional with respect to the hydroxyl groups. It is preferred to use di-, tri- or polyfunctional starter compounds, which exhibit advantages in respect of the polydispersity and certain physical properties. The hydroxyl groups of the difunctional or polyfunctional allylic starter compound are preferably etherified with a diol, triol or polyol, a dihydroxy-, trihydroxy- or polyhydroxy-ester or -polyester or a dihydroxy-, trihydroxy- or polyhydroxy-ether or polyether, such as, for example, with a 5,5-dihydroxyalkyl-1,3-dioxane, a 5,5-di(hydroxy-alkoxy)-1,3-dioxane, a 5,5-di(hydroxyalkoxyalkyl)-1,3-dioxane, a 2-alkyl-1,3-propanediol, a 2,2-dialkyl-1,3-propanediol, a 2-hydroxy-1,3-propanediol, a 2,2-dihydroxy-1,3-propanediol, a 2-hydroxy-2-alkyl-1,3-propanediol, a 2-hydroxyalkyl-2-alkyl-1,3-propanediol, a 2,2-di(hydroxyalkoxy)-1,3-propanediol, a 2-hydroxyalkoxy-2-alkyl-1,3-propanediol, a 2,2-di(hydroxyalkoxy)-1,3-propanediol, a 2-(hydroxyalkoxyalkyl-2-alkyl-1,3-propanediol or a 2,2-di(hydroxyalkoxyalkyl)-1,3-propanediol.

Preferred embodiments of the stated difunctional or polyfunctional allylic starter compound are etherified with dimers, trimers or polymers of 5,5-dihydroxyalkyl-1,3-dioxanes, 5,5-di(hydroxyalkoxy)-1,3-dioxanes, 5,5-di(hydroxyalkoxyalkyl)-1,3-dioxanes, 2-alkyl-1,3-propanediols, 2,2-dialkyl-1,3-propandiols, 2-hydroxy-1,3-propanediols, 2,2-dihydroxy-1,3-propanediols, 2-hydroxy-2-alkyl-1,3-propanediols, 2-hydroxyalkyl-2-alkyl-1,3-propanediols, 2,2-di(hydroxyalkyl-1,3-propanediols, 2-hydroxyalkoxy-2-alkyl-1,3-propanediols, 2,2-di(hydroxyalkoxy)-1,3-propanediols, 2-hydroxyalkoxyalkyl-2-alkyl-1,3-propanediols and 2,2-di(hydroxyalkoxyalkyl)-1,3-propanediols.

The stated alkyl radicals are preferably linear or branched C₁-C₂₄, such as C₁-C₁₂ or C₁-C₈, for example, alkyls or alkenyls. Particularly preferred alkyl radicals are methyl and ethyl radicals. The expression “alkoxy” stands preferably for methoxy, ethoxy, propoxy, butoxy, phenylethoxy and comprises up to 20 alkoxy units or a combination of two or more alkoxy units.

Further-preferred embodiments of the allylic starter compound having at least two hydroxyl groups encompass monoallyl ethers or monomethallyl ethers of glycerol, of trimethylolethane and trimethylolpropane, monoallyl, diallyl, mono(methallyl) or di(methallyl) ethers of di(trimethylol)ethane, of di(trimethylol)propane and of pentaerythritol, and also of 1,Ω-diols, such as, for example, mono-, di-, tri- and polyethylene glycols, mono-, di-, tri- and polypropylene glycols, 1,4-butanediol, 1,5-pentanediol, 1,6-hexanediol, 1,6-cyclohexanedimethanol and their correspondingly alkyl-, alkylalkoxy- and alkoxyalkyl-substituted analogues and also their derivatives. The designations “alkyl” and “alkoxy” correspond here to the definitions stated above.

With particular preference the allylic starter compound having at least two hydroxyl groups is derived from a compound from the group consisting of 5,5-dihydroxymethyl-1,3-dioxane, 2-methyl-1,3-propanediol, 2-methyl-2-ethyl-1,3-propanediol, 2-ethyl-2-butyl-1,3-propanediol, neopentyl glycol, dimethylolpropane, glycerol, trimethylolethane, trimethylolpropane, diglycerol, di(trimethylolethane), di(trimethylolpropane), pentaerythritol, di(pentaerythritol), anhydroenneaheptitol, sorbitol and mannitol.

For the polymerization of the dendritic allylic polyethers it is particularly preferred to use allylic starter compounds having two hydroxyl groups, such as trimethylolpropane monoallyl ether or glycerol monoallyl ether, for example.

On allylic starter compounds of this kind the ring-opening cationic polymerization with hydroxyoxetanes takes place. These hydroxyoxetanes may be alkyl- or hydroxyalkyl-substituted. The hydroxyoxetanes used in accordance with the invention preferably comprise at least one 3-alkyl-3-(hydroxyalkyl)oxetane, 3,3-di(hydroxyalkyl)oxetane, one 3-alkyl-3-(hydroxyalkoxy)oxetane, one 3-alkyl-3-(hydroxyalkoxyalkyl)oxetane or a dimer, trimer or polymer of a 3-alkyl-3-(hydroxyalkyl)oxetane, of a 3,3-di(hydroxyalkyl)oxetane, of a 3-alkyl-3-(hydroxyalkoxy)oxetane or of a 3-alkyl-3-(hydroxyalkoxyalkyl)oxetane. “Alkyl” here stands preferably for linear or branched C₁-C₂₄, such as C₁-C₁₂ or C₁-C₈, for example, alkyls or alkenyls. With particular preference the expression “alkyl” stands for methyl and ethyl. The expression “alkoxy” stands preferably for methoxy, ethoxy, propoxy, butoxy, phenylethoxy and comprises up to 20 alkoxy units or a combination of two or more alkoxy units.

With particular preference use is made as hydroxyoxetane of at least one hydroxyoxetane selected from the group consisting of 3-methyl-3-(hydroxymethyl)-oxetane, 3-ethyl-3-(hydroxymethyl)oxetane and 3,3-di(hydroxymethyl)oxetane (trimethylolpropane oxetane). Mixtures of these compounds can also be used.

Further details on reactions, reactants and procedures are described inter alia in WO 02/40572.

The polyhydroxy-functional dendritic allyl compounds have at least one branching generation, preferably at least two branching generations. The expression “generation”, as in WO 02/40572, is also used in the present case to designate pseudo-generations. The polydispersity of the dendritic allyl compounds is preferably <2.8, more preferably <1.7.

The formula (II) below shows a dendrimer-like reaction product, obtained preferably, which is obtainable from trimethylolpropane monoallyl ether and trimethylolpropane oxetane in a second generation. As can be seen from the formula, a dendrimer of second pseudo-generation is formed.

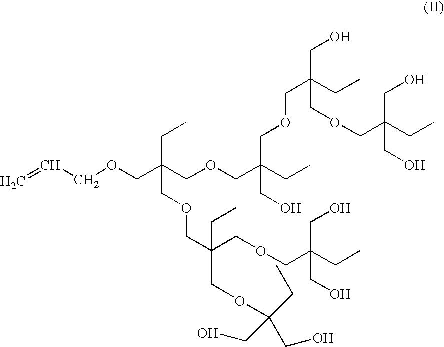

The polyhydroxy-functional polysiloxanes can be prepared by reaction of at least one allylic starter compound with at least one oxetane and subsequent addition reaction with the Si—H-functional alkylpolysiloxane. Synthesis of the polyhydroxy-functional polysiloxanes can alternatively take place by addition reaction of the at least one allylic starter compound with the Si—H-functional alkylpolysiloxane and subsequent reaction with at least one oxetane. Preference is given to reaction of the at least one allylic starter compound with at least one oxetane and subsequent addition reaction with the Si—H-functional alkylpolysiloxane.

The polyhydroxy-functional polysiloxanes can also be prepared by reaction of a starter compound which instead of the allyl radical bears a corresponding hydroxyalkyl radical with at least one oxetane and subsequent condensation reaction with the Si—H-functional alkylpolysiloxane. Synthesis of the polyhydroxy-functional polysiloxanes can alternatively take place by condensation reaction of the hydroxyalkyl-functional starter compound with the Si—H-functional alkylpolysiloxane and subsequent reaction with the at least one oxetane. Also possible is a reaction of the allylic starter compound with at least one oxetane, followed by an addition reaction of water to the allylic double bond, and condensation reaction with the Si—H-functional alkylpolysiloxane.

The synthesis of the polyhydroxy-functional polysiloxanes is accomplished preferably via addition reaction of the allyl polyethers, obtained by reaction of the allylic starter compound with at least one oxetane, with the Si—H-functional alkylpolysiloxane.

In order to improve the compatibility of the polyhydroxy-functional polysiloxanes prepared from these polyhydroxy-functional allyl polyethers, it is also possible to alkoxylate the free hydroxyl groups of the allyl polyethers or of the hydroxyalkyl polyethers, before or after the hydrosilylation reaction or condensation reaction with the Si—H-functional polysiloxane. Preferably the groups are ethoxylated and/or propoxylated and/or butoxylated and/or alkoxylated with styrene oxide. It is possible here to prepare pure alkoxylates or mixed alkoxylates. With particular preference the free hydroxyl groups of the allyl polyethers or of the hydroxyalkyl polyethers are ethoxylated.

Additionally, apart from an alkoxylation, the free hydroxyl groups may also be modified chemically in other ways. Examples include methylation, acrylization, acetylation, esterification, and conversion to the urethane by reaction with isocyanates. The aforementioned chemical conversions need not be complete. For instance, it is also possible for only some of the free hydroxyl groups, i.e., in particular at least one hydroxyl group, to have been chemically modified.

The modification is preferably carried out before the hydrosilylation reaction. In this case the modification of the free hydroxyl groups may also have a beneficial effect on the subsequent hydrosilylation reaction.

By way of the fraction of the free hydroxyl groups in the polyhydroxy-functional allyl polyether it is also possible to control the incorporability and/or the crosslinking density of the polyhydroxy-functional polysiloxane in the binder. If many or all of the original hydroxyl functions are retained, a higher crosslinking density is obtained, which can lead to improved hardness on the part of the coating system. Contrastingly, if substantially all of the hydroxyl groups are blocked, the molecule retains a certain mobility and, in the case of a multi-coat coating system, is able to migrate through the coats, so that the intercoat adhesion is not adversely affected.

In order to be able to adapt compatibilities of the polyhydroxy-functional polysiloxanes with the coating compositions, the polymeric moulding compounds and the thermoplastics, it can be sensible to use, in combination with the polyhydroxy-functional allyl compounds that are used in accordance with the invention, allyl polyethers as well, which are prepared by the alkoxylation of allyl alcohol or monoallyl ethers having one or more hydroxyl groups with alkylene oxides, more particularly ethylene oxide and/or propylene oxide and/or butylene oxide and/or styrene oxide. These already very well-established allyl polyethers are referred to below, for improved clarity, as “unbranched allyl polyethers” and they lead to “unbranched polyether radicals” Z—RK in the polysiloxane. In this context it is possible to prepare not only pure alkoxylates but also mixed alkoxylates. In mixed alkoxylates the alkoxylation may be blockwise, alternating or random. The mixed alkoxylates may also contain a distribution gradient in respect of the alkoxylation.

The end groups or end group of the unbranched allyl polyether may be hydroxy-functional or else, as described above, may have been converted, by methylation or acetylation, for example.

The unbranched polyether radical RK is preferably an ethylene oxide, ([EO]), a propylene oxide ([PO]) or an ethylene oxide-propylene oxide copolymer of the following formula (III)

RK=—O—[EO]ᵥ—[PO]_{w}—R⁶ (III)
with v=0-70; if v=0 then w≧1;
with w=0-50; if w=0 then v≧1;
R⁶ being an aliphatic, aromatic or araliphatic compound which may also contain heteroatoms, such as H, alkyl, ester, allyl, (meth)acryloyl, urethane, for example.

By means of different fractions of ([E0]) and ([PO]) it is possible to influence the properties of the polysiloxane of the invention. Thus it is possible especially on account of the greater hydrophobicity of the [PO] units as compared with the [EO] units to control the hydrophobicity of the polysiloxane of the invention through the choice of suitable [EO]:[PO] ratios.

The copolymers corresponding to the structural formula indicated above may be random copolymers, alternating copolymers or block copolymers. It is also possible for a gradient to be formed by the sequence of the alkylene oxide units.

It is possible to use not just one unbranched allyl polyether. For improved control of the compatibility it is also possible to use mixtures of different unbranched allyl polyethers.

The reaction can be carried out in such a way that the unbranched allyl polyethers and the branched allyl polyethers are subjected in succession to addition reaction with the Si—H-functional alkylpolysiloxane. Alternatively the allyl polyethers can be mixed prior to the addition reaction, so that then the allyl polyether mixture is subjected to addition reaction with the Si—H-functional alkylpolysiloxane.

Unbranched polyethers are also understood to include corresponding monohydroxy-functional polyethers, deriving from triols and polyols such as glycerol or fatty alcohols, for example, as starter alcohols. These monohydroxy-functional polyethers are frequently prepared by ethoxylation and/or propoxylation and/or butoxylation and/or alkoxylation with styrene oxide of monoalcohols, examples being butanol, ethanol, methanol, allyl alcohol, or other starter alcohols, fatty alcohols for example. They can be incorporated into the polysiloxane by condensation reaction of corresponding compounds HO—Z—RK containing silane hydrogen atoms. Mixtures of different monohydroxy-functional polyethers can also be used.

The process for preparing the polyhydroxy-functional polysiloxanes may be carried out via the condensation reaction of inventive and optionally monohydroxy-functional polyethers and/or the addition reaction of inventive and optionally unbranched allyl polyethers in one stage (i.e. unbranched hydroxyalkyl polyethers in a mixture with branched hydroxyalkyl polyethers) or two stages. Preferably it is carried out in two stages. With particular preference, in the first stage, the monohydroxy-functional unbranched polyether or polyethers is or are subjected to condensation reaction with the Si—H-functional alkylpolysiloxane. Then, in the second stage, the polyhydroxy-functional allyl polyether or polyethers is or are subjected to addition reaction with the Si—H-functional alkylpolysiloxane.

In order to be able to adapt compatibilities of the polyhydroxy-functional polysiloxanes with the coating compositions, the polymeric moulding compounds and the thermoplastics, it may be sensible, in combination with the polyhydroxy-functional allyl compounds used in accordance with the invention, to use allyl polyesters as well that can be obtained by the esterification of alcohols having an allylic double bond (1-alkenols, such as 1-hexenol, or hydroxy-functional allyl polyethers, such as ethylene glycol monoallyl ether, diethyl glycol monoallyl ether or higher homologues) with hydroxycarboxylic acids, and/or cyclic esters. The esterification takes place preferably by way of a ring-opening polymerization with propiolactone, caprolactone, valerolactone or dodecalactone, and derivatives thereof. With particular preference the ring-opening polymerization takes place with caprolactone. In this context it is possible to prepare not only pure polyesters but also mixed polyesters. In the case of mixed polyesters the esterification may be blockwise, alternating or random. The mixed polyesters may also contain a distribution gradient in respect of the esterification.

The end groups of the allyl polyester may be hydroxy-functional or else may have been converted, by means of methylation or acetylation, for example.

The weight-average molecular weights of the allyl polyesters can be between 200 and 4000 g/mol, preferably between 300 and 2000 g/mol and with particular preference between 400 and 1000 g/mol.

The reaction can be carried out in such a way that the allyl polyesters and the branched allyl polyethers are subjected in succession to addition reaction with the Si—H-functional alkylpolysiloxane. Alternatively the branched allyl polyethers and the allyl polyesters can be mixed prior to the addition reaction, so that then this mixture is subjected to addition reaction with the Si—H-functional alkylpolysiloxane.

In order to be able to adapt compatibilities of the polyhydroxy-functional polysiloxanes with the coating compositions, the polymeric moulding compounds and the thermoplastics, it may be sensible, in combination with the polyhydroxy-functional allyl compounds used in accordance with the invention, to use mixtures as well of the aforementioned unbranched allyl polyethers and allyl polyesters.

Generally speaking the compatibilities of the polyhydroxy-functional polysiloxanes can be adapted to any of a very wide variety of matrices. In order to use the polyhydroxy-functional polysiloxanes in polycarbonates, for example, corresponding polycarbonate modifications can be built into the polyhydroxy-functional polysiloxanes, in the way described, for example, in U.S. Pat. No. 6,072,011.

Particular preference for use in coating compositions, polymeric moulding compounds and thermoplastics without compatibility problems is given to polysiloxanes of the general formula (IV)

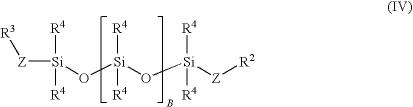

where
Z=C₁-C₁₄ alkylene,
and where at least one substituent from the group consisting of R² and R³ stands for R and the other stands for C₁-C₁₄ alkyl, aryl or aralkyl, —O(C₁-C₁₄ alkyl, aryl or aralkyl), —OCO(C₁-C₁₄ alkyl, aryl or aralkyl), —O—CO—O(C₁-C₁₄ alkyl, aryl or aralkyl), —OSO₂(C₁-C₁₄ alkyl, aryl or aralkyl), —H, —Cl, —F, —OH, —R, or —RK, where
RK=unbranched polyether radical composed of alkylene oxide units having 1-6 carbon atoms, or aliphatic and/or cycloaliphatic and/or aromatic polyester radical having a weight-average molecular weight of between 200 and 4000 g/mol and
R=polyhydroxy-functional branched polyether radical,
R⁴=C₁-C₁₄ alkyl, aryl or aralkyl,
B=2-300, preferably 10-200, more preferably 15-100.

These compounds correspond to the compounds represented in the general formula (I) for the case A=0 and C=0 for the case that at least one of the two substituents R² and R³ is a polyhydroxy-functional branched polyether radical R.

Particularly preferred compounds are the compounds of the general formula (IV) for which R²=R³=R. On the basis of the terminal polyhydroxy-functional branched polyether radicals, they display improved activity in many cases. They can be employed with advantage in coating compositions, polymeric moulding compounds and thermoplastics that do not require any compatibility adaptation by means of radicals RK.

The Si—H-functional alkylpolysiloxanes used may also be strictly monofunctional; in other words, they may have only one silane hydrogen atom. With these compounds it is possible to produce preferred compounds in which exactly one of the groups R² and R³ stands for a radical R. The Si—H-functional alkylpolysiloxanes may be represented, for example, by the following general formula (V):

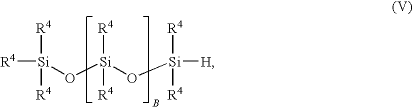

for which the abovementioned definitions of R⁴ and B apply. These compounds yield polyhydroxy-functional polysiloxanes of the general formula (VI)

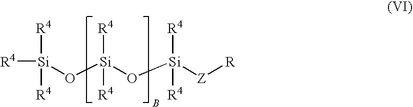

These linear monofunctional polysiloxanes can be synthesized, for example, via living anionic polymerization of cyclic polysiloxanes. This process is described, inter alia, in T. Suzuki, Polymer, 30 (1989) 333. The reaction is depicted exemplarily in the following reaction scheme:

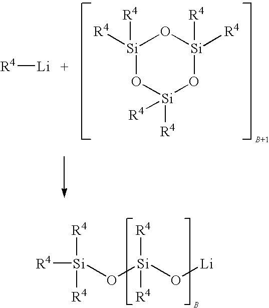

The SiH(R⁴)₂ functionalization of the end group can take place with functional chlorosilanes, dialkyl-chlorosilane for example, in analogy to the following reaction scheme, by a process known to a person of ordinary skill in the art.

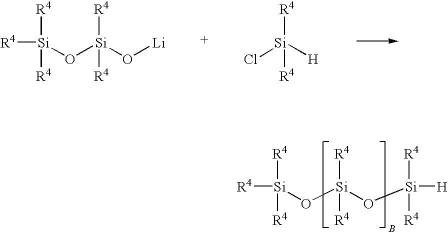

A further possibility for the preparation of linear, monofunctional polysiloxanes is the equilibration of cyclic and open-chain polydialkylsiloxanes with terminally Si—H-difunctional polydialkylsiloxanes, as described in Noll (Chemie and Technologie der Silicone, VCH, Weinheim, 1984). For statistical reasons the reaction product is composed of a mixture of cyclic, difunctional, monofunctional and non-functional siloxanes. The fraction of linear siloxanes in the reaction mixture can be increased by distillative removal of the lower cyclic species. Within the linear polysiloxanes the fraction of SiH(R⁴)₂-monofunctional polysiloxanes in the equilibration reaction product ought to be exceedingly high. If mixtures of linear polysiloxanes are used, the activity of the later products of the invention follows the rule whereby this activity increases as the fraction of monofunctional end products of the invention increases. When mixtures are used, the fraction of the monofunctional end products of the invention ought preferably to be the greatest fraction in the mixture and ought more preferably to amount to more than 40% by weight. Typical equilibration products depleted of cyclic impurities contain preferably less than 40% by weight of difunctional and less than 15% by weight of non-functional linear polysiloxanes, the latter being present in particular at less than 5% by weight, and ideally not at all.

One example of a polyhydroxy-functional polysiloxane of the invention with terminal functionalization, comprising a polysiloxane having terminal Si—H groups, is shown by the following formula (VII):

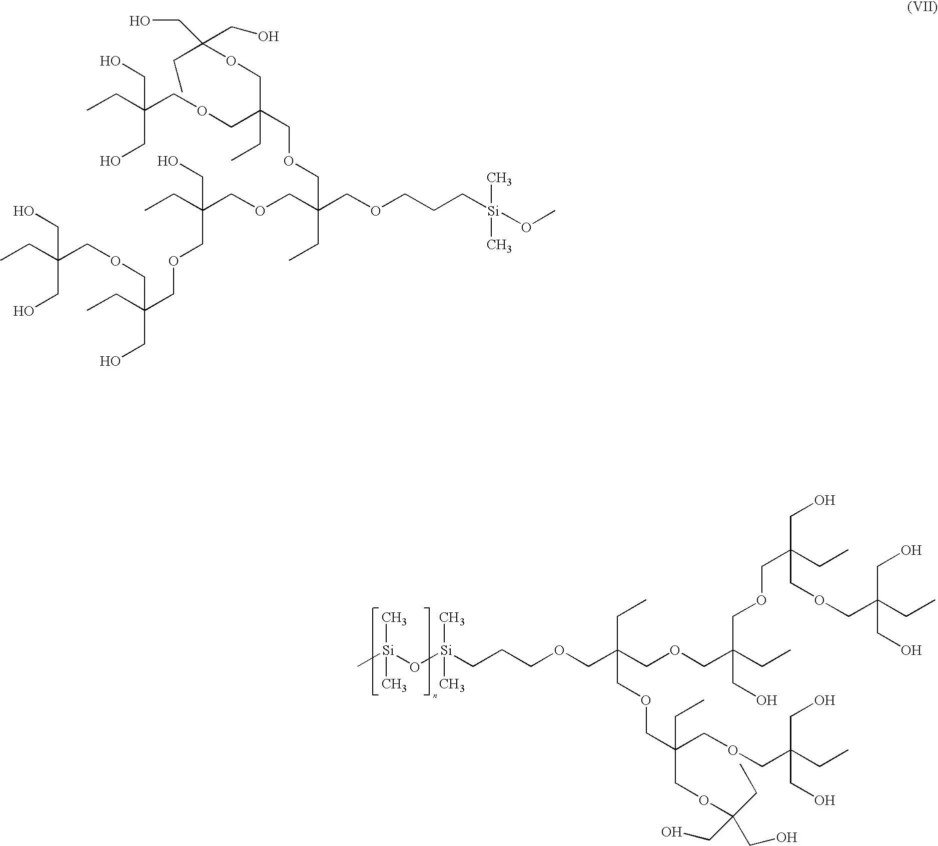

A reaction example of a monofunctional silicone having a dendrimer-like polyether radical is shown by the following formula (VIII):

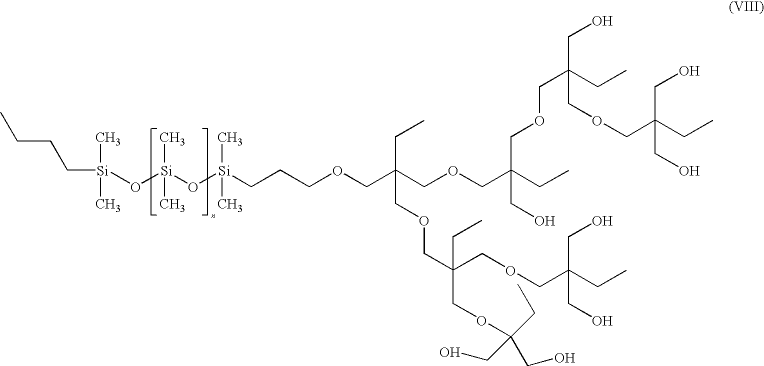

Typically the hydrosilylation takes place under the following conditions: the Si—H-functional alkyl-polysiloxane is introduced at room temperature. Then, for example, 25 to 100 ppm of a potassium acetate solution are added, in order to suppress any secondary reactions. Depending on the anticipated heat given off by the reaction, a portion or the entirety of the allyl compounds is added. Under a nitrogen atmosphere the contents of the reactor are then heated to 75° C. to 80° C. At this point a catalyst is added, such as a transition metal, nickel for example, nickel salts, iridium salts or, preferably, a noble metal from group VIII, such as hexachloroplatinic acid or cisdiammineplatinum(II) dichloride. The exothermic reaction which then takes place raises the temperature. Normally an attempt is made to keep the temperature within a range from 90° C. to 120° C. If there is still a portion of the allyl compounds to be metered in, the addition takes place in such a way that the temperature of 90° C. to 120° C. is not exceeded, but also such that the temperature does not drop below 70° C. Following complete addition, the temperature is held at 90° C. to 120° C. for a certain time. The course of the reaction can be monitored by infrared spectroscopy for the disappearance of the silicon hydride absorption band (Si—H: 2150 cm⁻¹).

The polyhydroxy-functional polysiloxanes of the invention can also be subsequently modified chemically in order, for example, to bring about certain compatibilities with binders. The modifications may be an acetylation, a methylation, a reaction with monoisocyanates, or a partial reaction with diisocyanates. In addition, by reaction with carboxylic anhydrides, such as with phthalic anhydride or succinic anhydride, for example, it is possible to install acid functions. The hydroxyl groups in this case may be partially or fully reacted. By reaction with corresponding unsaturated anhydrides, maleic anhydride for example, it is possible to install not only a carboxyl group but also one or more reactive double bonds into the molecule. The hydroxyl functions in this case may also be reacted with structurally different anhydrides. In order to achieve better solubility in water, the carboxyl groups may also be salified with alkanolamines. A further possibility, through subsequent acrylation or methacrylation on the hydroxyl groups, is to obtain products which can be installed firmly into coating systems even in radiation-curing operations, such as UV curing and electron-beam curing. The hydroxyl groups can also be esterified by ring-opening polymerization with propiolactone, caprolactone, valerolactone or dodecalactone, and derivatives thereof. With particular preference the ring-opening polymerization takes place with caprolactone. Both pure polyesters and mixed polyesters can be prepared here. In the case of mixed polyesters the esterification can be blockwise, alternating or random. It is also possible for the mixed polyesters to contain a distribution gradient in respect of the esterification.

The invention further provides coating compositions, polymeric moulding compounds and thermoplastics comprising the polyhydroxy-functional polysiloxanes of the invention.

The coating compositions, polymeric moulding compounds and thermoplastics produced using the polyhydroxy-functional polysiloxanes of the invention may be used in pigmented or unpigmented form and may also comprise fillers such as calcium carbonate, aluminium hydroxide, reinforcing fibres such as glass fibres, carbon fibres and aramid fibres. Furthermore, the coating compositions, polymeric moulding compounds and thermoplastics produced using the polyhydroxy-functional polysiloxanes of the invention may comprise other customary additives, such as wetting agents and dispersants, light stabilizers, ageing inhibitors and the like, for example.

The coating compositions produced using the polyhydroxy-functional polysiloxanes of the invention preferably comprise at least one binder. The coating compositions produced using the polyhydroxy-functional polysiloxanes of the invention are preferably coating compositions for producing anti-graffiti coatings, release coatings, self-cleaning façade coatings, ice-repelling coatings (for aircraft, for example), car wheel coatings, dirt-repelling machine and instrument coatings, marine coatings (anti-fouling coatings), and dirt-repelling furniture coatings and release-paper coatings. Owing to the very good compatibility of the polyhydroxy-functional polysiloxanes, they are also outstandingly suitable for producing transparent coatings.

The coating compositions and polymeric moulding compounds of the invention contain the polyhydroxy-functional polysiloxane additives in amounts of 0.1% to 10% by weight, preferably of 0.5% to 7.5% by weight, with very particular preference of 1% to 5% by weight, based on the solids content of the coating composition or polymeric moulding compound. The polyhydroxy-functional polysiloxanes are preferably added as solution or emulsions to the coating compositions or polymeric moulding compounds of the invention.

The thermoplastics of the invention contain the polyhydroxy-functional polysiloxane additives in amounts of 0.1% to 5% by weight, preferably of 0.2% to 2.0% by weight, with very particular preference of 0.5% to 1% by weight, based on the solids content of the thermoplastic. The polyhydroxy-functional polysiloxanes are preferably added as solids to the thermoplastics of the invention.

The coating compositions produced using the polyhydroxy-functional polysiloxanes of the invention may be applied to a large number of substrates, such as wood, paper, glass, ceramic, plaster, concrete and metal, for example. In a multi-coat process the coatings may also be applied to primers, primer-surfacers or base coats. Curing of the coating compositions depends on the particular type of crosslinking and may take place within a wide temperature range of, for example, −10° C. to 250° C. Surprisingly, the coating compositions produced using the polyhydroxy-functional polysiloxanes of the invention display very good anti-adhesive dirt-repelling properties even when cured at room temperature. Furthermore, the coating compositions produced using the polyhydroxy-functional polysiloxanes of the invention exhibit good antistatic properties.

Owing to the extraordinarily good anti-adhesive effect of the coating compositions of the invention, even oily substances such as mineral oils, vegetable oils or oily preparations for example, are repelled so enabling full discharge from corresponding oil-containing vessels. Accordingly, the coating compositions thus additized are also suitable for can interior coatings and drum interior coatings. On the basis of the antistatic properties of the coating compositions additized accordingly, they are suitable for use whenever disadvantageous effects caused by electrostatic charging are to be avoided.

The polymeric moulding compounds produced using the polyhydroxy-functional polysiloxanes of the invention are preferably lacquer resins, alkyd resins, polyester resins, epoxy resins, polyurethane resins, unsaturated polyester resins, vinyl ester resins, polyethylene, polypropylene, polyamides, polyethylene terephthalate, PVC, polystyrene, polyacrylonitrile, polybutadiene, polyvinyl chloride or blends of these polymers.

The thermoplastics produced using the polyhydroxy-functional polysiloxanes of the invention are poly(meth)acrylates, polyacrylonitrile, polystyrene, styrenic plastics (e.g. ABS, SEBS, SBS), polyesters, polyvinyl esters, polycarbonates, polyethylene terephthalate, polybutylene terephthalate, polyamides, thermoplastic polyurethanes (TPU), polyvinyl chloride, polyoxymethylene, polyethylene or polypropylene. The thermoplastics may be filled and/or pigmented. The term “thermoplastics” in the sense of the invention also embraces blends of different kinds of thermoplastics. The thermoplastics may also, for example, be spinnable thermoplastic fibres known to a person of ordinary skill in the art, such as polyester fibres or polyamide fibres, for example.

The examples below illustrate the invention without restrictive effect:

### EXAMPLE 1

Reaction of a methylhydrosiloxane having the mean average formula M^{H}D₆₆M^{H} and allyl polyether 1.

A 250 ml 3-necked flask with stirrer, thermometer, and reflux condenser is charged at room temperature with 91.0 g of a methylhydrosiloxane having the mean average formula M^{H}D₆₆M^{H} and 39.13 g of allyl polyether 1 and this initial charge is heated under a nitrogen atmosphere to 80° C. When this temperature has been reached, 3 mg of cisplatin are added. The volume of heat liberated in the course of the reaction raises the temperature to 105° C. After 60 minutes at 105° C., the temperature is increased to 120° C. for two hours. Gas-volumetric determination of the remaining Si—H groups indicates complete conversion. A colourless, slightly turbid, pasty product is obtained.

### EXAMPLE 2

Reaction of a methylhydrosiloxane having the mean average formula M^{H}D₂₈M^{H} and allyl polyether 2.

A 250 ml 3-necked flask with stirrer, thermometer, and reflux condenser is charged at room temperature with 77.0 g of a methylhydrosiloxane having the mean average formula M^{H}D₂₈M^{H} and 36.95 g of allyl polyether 2 and this initial charge is heated under a nitrogen atmosphere to 80° C. When this temperature has been reached, 3 mg of cisplatin are added. The volume of heat liberated in the course of the reaction raises the temperature to 112° C. Over the course of 30 minutes the temperature is raised to 115° C. and held for two hours. Gas-volumetric determination of the remaining Si—H groups indicates complete conversion. A colourless, slightly turbid, pasty product is obtained.

### EXAMPLE 3

Reaction of a methylhydrosiloxane having the mean average formula M^{H}D₆₆D^{H}₂M^{H} and allyl polyether 1 and allyl polyether K1.

A 250 ml 3-necked flask with stirrer, thermometer, and reflux condenser is charged at room temperature with 49.36 g of a methylhydrosiloxane having the mean average formula M^{H}D₆₆D^{H}₂M^{H}, 10.92 g of allyl polyether K1 and 19.72 g of allyl polyether 1 and this initial charge is heated under a nitrogen atmosphere to 80° C. When this temperature has been reached, about 1 mg of cisplatin is added. The temperature is raised to 120° C. and the batch is held under these conditions for 150 minutes. Gas-volumetric determination of the remaining Si—H group indicates a degree of conversion of >99%. A light brown, virtually clear, highly viscous product is obtained.

### EXAMPLE 4

Reaction of a methylhydrosiloxane having the mean average formula M^{H}D₆₆M^{H} and allyl polyether 3.

A 250 ml 3-necked flask with stirrer, thermometer, and reflux condenser is charged at room temperature with 60.00 g of a methylhydrosiloxane having the mean average formula M^{H}D₆₆M^{H}, 50.20 g of allyl polyether 3 and 47.19 g of xylene and this initial charge is heated under a nitrogen atmosphere to 80° C. When this temperature has been reached, about 4 mg of cisplatin are added. The temperature rises to 114° C. as a result of heat given off. The batch is held at a temperature of 110° C. for 120 minutes. Gas-volumetric determination of the remaining Si—H group after this time has elapsed indicates complete conversion. In the subsequent distillation, under a reduced pressure of approximately 20 mbar at 130° C., all of the volatile constituents are distilled off in an hour. A light brown, virtually clear, highly viscous product is obtained.

### EXAMPLE 5

Reaction of a methylhydrosiloxane having the mean average formula M^{H}D₄₈D^{H}₂M^{H} and allyl polyether 1 and allyl polyether K2.

A 250 ml 3-necked flask with stirrer, thermometer, and reflux condenser is charged at room temperature with 39.53 g of a methylhydrosiloxane having the mean average formula M^{H}D₄₈D^{H}₂M^{H}, 19.9 g of allyl polyether K1, 20.57 g of allyl polyether 1 and 31.12 g of xylene and this initial charge is heated under a nitrogen atmosphere to 80° C. When this temperature has been reached, about 5 mg of cisplatin are added. The temperature is raised to 120° C. and the batch is held under these conditions for 240 minutes. Gas-volumetric determination of the remaining Si—H group indicates a degree of conversion of 100%. In the subsequent distillation, under a reduced pressure of approximately 20 mbar at 130° C., all of the volatile constituents are distilled off in an hour. A light brown, clear, highly viscous product is obtained.

### EXAMPLE 6

Reaction of a terminally mono-Si—H-functional silicone macromer having the mean average formula MD₁₄M^{H} and allyl polyether 2

A 250 ml 3-necked flask with stirrer, thermometer, and reflux condenser is charged at room temperature with 100.0 g of a methylhydrosiloxane having the mean average formula MD₁₄M^{H} and 49.25 g of allyl polyether 2 and this initial charge is heated under a nitrogen atmosphere to 80° C. When this temperature has been reached, about 5 mg of cisplatin are added. The temperature is raised to 110° C. and the batch is held under these conditions for 120 minutes. Gas-volumetric determination of the remaining Si—H group indicates a degree of conversion of 100%. A light brown, turbid, highly viscous product is obtained.

### EXAMPLE 7

Reaction of a methylhydrosiloxane having the mean average formula MD₁₈M^{H} and allyl polyether 1

A 250 ml 3-necked flask with stirrer, thermometer, and reflux condenser is charged at room temperature with 71.8 g of a methylhydrosiloxane having the mean average formula MD₁₈M^{H}, 54.74 g of allyl polyether 1 and 23.46 g of xylene and this initial charge is heated under a nitrogen atmosphere to 80° C. When this temperature has been reached, about 5 mg of cisplatin are added. The temperature is raised to 110° C. and the batch is held under these conditions for 120 minutes. Gas-volumetric determination of the remaining Si—H group indicates a degree of conversion of 100%. A light brown, turbid, highly viscous product is obtained.

### EXAMPLE 8

Reaction of a methylhydrosiloxane having the mean average formula M^{H}D₄₈D^{H}₂M^{H} and allyl polyether 1 and allyl polyester 1.

A 250 ml 3-necked flask with stirrer, thermometer, and reflux condenser is charged at room temperature with 70.40 g of a methylhydrosiloxane having the mean average formula M^{H}D₄₈D^{H}₂M^{H}, 36.64 g of allyl polyether 1, 28.26 g of allyl polyester 1 and 15.19 g of xylene and this initial charge is heated under a nitrogen atmosphere to 80° C. When this temperature has been reached, about 5 mg of cisplatin are added. The temperature is raised to 110° C. and the batch is held under these conditions for 150 minutes. Gas-volumetric determination of the remaining Si—H group indicates a degree of conversion of 100%. In the subsequent distillation, under a reduced pressure of approximately 20 mbar at 130° C., all of the volatile constituents are distilled off in an hour. A light brown, slightly turbid, highly viscous product is obtained.

### Key

For the methylhydrosiloxanes indicated above, the definitions of the abbreviations given are defined as follows:

M=—O_{0.5}Si(CH₃)₃

M^{H}=—O_{0.5}SiH(CH₃)₂

D=—O_{0.5}Si(CH₃)₂O_{0.5}—

D^{H}=—O_{0.5}SiH(CH₃)O_{0.5}—

Abbreviations additionally used:

Allyl polyether 1=

Allyl polyether having theoretically 8 OH groups from the reaction of trimethylolpropane monoallyl ether with trimethylolpropane oxetane in a ratio of 1:6.

OH number=517 mg KOH/g

Iodine number=29.9 g I₂/100 g

Molecular weight Mw=2094 g/mol (measured in THF)

Polydispersity 1.3

Allyl polyether 2=

Allyl polyether having theoretically 4 OH groups from the reaction of trimethylolpropane monoallyl ether with trimethylolpropane oxetane in a ratio of 1:2.

Iodine number=63.3 g I₂/100 g

Allyl polyether 3=

Allyl polyether ethoxylate having theoretically 8 OH groups from the reaction of trimethylolpropane monoallyl ether with trimethylolpropane oxetane in a ratio of 1:6 and subsequent ethoxylation with about 18 mol of ethylene oxide

OH number=264 mg KOH/g

Iodine number=15.2 g I₂/100 g

Allyl polyether K1=

Unbranched allyl polyether, ethylene oxide polyether prepared starting from allyl alcohol,

Molecular weight about 450 g/mol

Iodine number=54.3 g I/100 g

Allyl polyether K2=

Unbranched allyl polyether, ethylene oxide-propylene oxide polyether prepared starting from allyl alcohol, with 75 mol % ethylene oxide and 25 mol % propylene oxide,

Molecular weight about 750 g/mol

Iodine number=30.5 g I/100 g

Allyl polyester 1=

Caprolactone polyester prepared starting from hexenol with an average of 5 mol of caprolactone.

(IN=37.3 g I₂/100 g)

Cisplatin=cisdiammineplatinum(II) dichloride

### Performance Testing of the Polyhydroxy-Functional Polysiloxanes of the Invention

The polyhydroxy-functional polysiloxanes of the invention were performance-tested in a number of varnish systems.

### Aqueous 2-Component System Based on Bayhydrol VP LS 2235/Bayhydur 3100

Component 1 (base varnish):

| | |
|---|---|
| Bayhydrol VP LS 2235¹⁾ | 70.90 |
| BYK-011²⁾ | 1.40 |
| Water | 1.10 |

Component 2 (curing agent):

| | |
|---|---|
| Bayhydur 3100³⁾ | 22.00 |
| Dowanol PMA | 4.60 |

The mixture is homogenized by stirring.
¹⁾Polyacrylate dispersion, Bayer Material Science AG, D-Leverkusen
²⁾Defoamer, BYK-Chemie GmbH, D-Wesel
³⁾Isocyanate-based curing component, Bayer Material Science AG, D-Leverkusen

Base varnish and curing solution are prepared independently of one another. The additives of the invention and the comparison products are stirred into the base varnish in a concentration of 1% by weight of active substance based on the total varnish.

Shortly before application, base varnish and curing solution are mixed in a ratio of 100:36.2. The viscosity is adjusted by adding water to a flow time of 30 seconds in the DIN 4 mm cup.

Following incorporation, the additized varnishes are applied to a primed aluminium panel in a 100 μm wet film using a wire-wound coating rod. Thereafter the panels are dried at room temperature for 60 hours. The dried panels are subsequently subjected to the tests specified below.

### Water-Thinable Acrylate/Melamine Baking System Based on Neocryl XK101 and Cymel 303

| | |
|---|---|
| Neocryl XK 101⁴⁾ | 78.90 |
| Water | 6.20 |
| Cymel 303³⁾ | 8.30 |
| NMP | 6.20 |
| DMEA | 0.40 |

⁴⁾Acrylate emulsion, DSM neoresins, NL-Wallwijk
⁵⁾Crosslinker, Cytec Industries Inc., USA-West Paterson, NJ

All of the components are mixed and the mixture is homogenized for 10 minutes with a dissolver at a peripheral speed of 5 m/s. The additives for testing are incorporated into the varnish at a concentration of 1% active substance over 10 minutes, using a Skandex shaker.

Following incorporation, the additized varnishes are applied to a primed aluminium panel in a 100 μm wet film using a wire-wound coating rod. After a flash-off time of 30 minutes at room temperature, the panels are baked in a forced-air oven at 130° C. for 30 minutes.

The coating films obtained are tested for their dirt, water and oil repellency in accordance with the following criteria:

### Edding Test:

The film surface is inscribed with an Edding 400 permanent marker and a visual assessment is made of whether the surface can be written on. An assessment is made of whether the ink spreads on the surface, or contracts. After the ink has dried, an attempt is made to remove it by wiping with a dry cloth.

Evaluation: 1-5
1=ink contracts, can be removed without residue using a paper cloth
5=ink spreads very well on the substrate, and is virtually impossible to remove

### Bitumen Test:

Bitumen is heated until it is sufficiently liquefied to be able to be applied to the film surface. After the bitumen mass has cooled, a visual assessment is made of how effectively it can be detached again from the surface manually without residue.

Evaluation: 1-5:
1=bitumen can be removed easily and without residue
5=bitumen adheres firmly to the surface and is virtually impossible to remove
   Staining with Bayferrox Powder:

3 spoonfuls of Bayferrox 130M iron oxide pigment from Bayer AG are scattered onto the film surface and rinsed off again using distilled water in 5 squirts using a wash bottle. The surface, free of residue as far as possible, is assessed visually.

Evaluation: 1-5:
1=Bayferrox powder can be washed off with water without residue
5=no cleaning effect on rinsing with water; a large red spot remains

### Water Run-Off Test:

One drop of water is placed on the surface. The coated film surface is then inclined until the drop runs off.

A visual assessment is made of the angle at which the drop runs off and of whether the drop runs off without residue.

Evaluation: 1-5:
1=small angle is sufficient for the drop to run off completely without forming a tear and without residual droplets
5=coated panel has to be inclined sharply until the drop runs off, with residues of water possibly remaining on the film surface

### Mineral Oil Run-Off Test:

One drop of commercially customary mineral oil is placed on the film surface. The coated film surface is then inclined until the drop has run about 10 cm. After 5 minutes, the oil track or drop reformation is evaluated visually.

Evaluation: 1-5:
1=the oil track immediately reforms into individual drops
5=the oil track does not reform, but instead possibly spreads further

### Aqueous 2-Component System Based on Bayhydrol VP LS 2235/Bayhydur 3100:

| | | | | Edding |
|---|---|---|---|---|
| | Oil | Bitumen | Edding | wipe-off |
| Control sample | 5 | 5 | 5 | 5 |
| Example 1 | 1 | 1 | 3 | 2 |
| Example 2 | 1 | 1 | 3 | 3 |
| Example 3 | 2 | 1 | 3 | 2 |
| Example 4 | 2 | 1 | 1 | 1 |
| Example 5 | 1 | 1 | 1 | 1 |
| Tego Protect 5100 | 1 | 1 | 4 | 2 |
| Worlee Add 720 | 3 | 3 | 5 | 5 |

Worlee Add 720: modified phenoldimethylsiloxane for producing aqueous and solvent-borne anti-graffiti coatings (Worlee-Chemie, D-Hamburg)

### Water-Thinnable Acrylate/Melamine Baking System Based on Neocryl XK101 and Cymel 303:

| | | | | | Edding |
|---|---|---|---|---|---|
| | Bayferrox | Oil | Bitumen | Edding | wipe-off |
| Control sample | 3 | 5 | 5 | 5 | 5 |
| Example 3 | 1 | 2 | 1 | 1 | 1 |
| Example 4 | 1 | 1 | 1 | 1 | 1 |
| Example 6 | 1 | 1 | 1 | 1 | 1 |
| Example 7 | 1 | 1 | 1 | 1 | 1 |
| Worlee Add 720 | 5 | 2 | 1 | 1 | 2 |

Worlee Add 720: modified phenoldimethylsiloxane for producing aqueous and solvent-borne anti-graffiti coatings, 50% strength solution in solvent mixture (Worlee-Chemie, D-Hamburg)

### Performance Testing of the Polyhydroxy-Functional Polysiloxanes of the Invention in Polymeric Moulding Compounds

A 50% strength solution in 1-methoxy-2-propyl acetate is prepared of the polyhydroxy-functional polysiloxane from Example 3. This polysiloxane solution is converted in accordance with the table below into the polymeric moulding compounds A and B (gel coat mixture A and gel coat mixture B).

Gel coat formulation:

| Palatal 400-01 | 84.75%, polyester resin, DSM resins |
|---|---|
| Aerosil 200 | 1.25%, fumed silica, Degussa |
| Tronox R-KB-2 | 10.00%, titanium dioxide, |
| | Tronox |
| Beschleuniger NL-49 P | 1.00%, cobalt octoate |
| | accelerant, 1% strength, Akzo Nobel |
| Styrene | 8.00% |

Palatal 400-01, Tronox R-KB-2 and Aerosil 200 are premixed using a dissolver at approximately 2800 rpm for five minutes. Thereafter, before the Beschleuniger NL49 P is used, the styrene is mixed in at 900 rpm. In the case of gel coat mixture A, the polysiloxane solution from Example 3 is added as well.

Formulation (in percent by weight) for the gel coat mixtures tested:

| | Gel Coat | Gel Coat |
|---|---|---|
| | Mixture A | Mixture B |
| Gel coat | 98.5 | 98 |
| Beschleuniger NL-49 P | 1 | 2 |
| Polysiloxane solution | 0.5 | |
| from Example 3 | | |

The anti-adhesive properties of these gel coat mixtures are determined by the adhesion of these gel coats to glass plates. For this purpose, glass plates measuring 40×10×0.05 cm are first of all thoroughly degreased by washing with ethyl acetate.

Subsequently the gel coat mixtures A and B are applied to the glass plate using a frame-type coating bar (750 μm slot). All of the gel coats are left to cure at room temperature overnight. After curing, the gel coat is removed from the plate using a carpet knife.

### Result

Gel coat mixture B cannot be removed from the glass plate. The gel coat mixture A, equipped with an internal release agent, is easy to remove from the unwaxed metal plate. The surface of the gel coat mixture A, equipped with an internal release agent, from the unwaxed metal plate is absolutely smooth and exhibits a high gloss.

### Performance Testing of the Polyhydroxy-Functional Polysiloxanes of the Invention in Thermoplastics

0.05 g of each of the products from Examples 6 and 7 were dissolved each in 100 g of a 10% strength solution of polymethyl methacrylate in n-ethyl acetate. A film 200 μm thick was produced in each case on a glass plate measuring 100×250 mm. Removal of the solvent gave a coating having a film thickness of approximately 20 μm. As a sample for comparison, a corresponding coating on glass without additive was used. In order to measure the sliding resistance, an electric film applicator device with constant rate of advance was used. A tensile force transducer which, via a computer, records any resistance which opposes the sliding body was fixed on the mount for the film applicator device. The sliding body is moved in the drawing direction over the surface to be measured. The sliding body used was a 500 g weight having a defined felt bottom layer.

The transparency/clouding of the coating was assessed purely by visual means.

| | Sliding resistance | |
|---|---|---|
| Sample | in newtons | Transparency |
| Control sample | 5.3 | transparent |
| without additive | | |
| Example 6 | 1.5 | transparent |
| Example 7 | 1.7 | transparent |
| Worlee Add 720 | 2.3 | transparent |

1.-34. (canceled)

35. A polyhydroxy-functional polysiloxane, wherein the polyhydroxy-functional polysiloxane is prepared via an addition reaction of at least one branched dendritic polyhydroxy-functional allyl polyether with an Si—H-functional alkylpolysiloxane, whereby the at least one branched dendritic polyhydroxy-functional allyl polyether is prepared by a ring-opening polymerization of at least one hydroxyoxetane with one or more hydroxy-bearing allylic starter compounds.

36. The polyhydroxy-functional polysiloxane according to claim 35, wherein the Si—H-functional alkylpolysiloxane is a methylhydropolysiloxane.

37. The polyhydroxy-functional polysiloxane according to claim 35, wherein the Si—H-functional alkylpolysilioxane is a chain polymer, a cyclic polymer, a branched polymer, or a crosslinked polymer.

38. The polyhydroxy-functional polysiloxane according to claim 35, wherein the polyhydroxy-functional polysiloxane is represented by the general formula 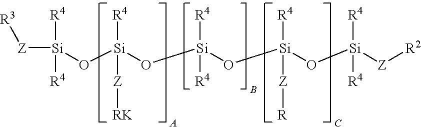
wherein
Z is C₁-C₁₄ alkylene;
RK is an unbranched polyether radical composed of alkylene oxide units having 1-6 carbon atoms or an aliphatic, cycloaliphatic, or aromatic polyester radical having a weight-average molecular weight of between 200 and 4000 g/mol;
R is a polyhydroxy-functional branched polyether radical;
R² and R³ are each independently (C₁-C₁₄ alkyl, aryl, or aralkyl), —O(C₁-C₁₄ alkyl, aryl, or aralkyl), —OCO(C₁-C₁₄ alkyl, aryl, or aralkyl), —O—CO—O(C₁-C₁₄ alkyl, aryl, or aralkyl), —OSO₂(C₁-C₁₄ alkyl, aryl, or aralkyl), —H, —Cl, —F, —OH, —R, or —RK;
R⁴ is C₁-C₁₄ alkyl, aryl, or aralkyl;
A is 0-20;
B is 2-300; and
C is 0-20; and
if C is 0 then R³ is R or R² is R.

39. The polyhydroxy-functional polysiloxane according to claim 38, wherein the polyhydroxy-functional polysiloxane is composed of 10 to 100 siloxane units.

40. The polyhydroxy-functional polysiloxane according to claim 38, wherein the polyhydroxyfunctional branched polyether alkyl radical —Z—R is introduced into the polyhydroxy-functional polysiloxane by an addition reaction of a dendritic polyhydroxy-functional allyl polyether.

41. The polyhydroxy-functional polysiloxane according to claim 38, wherein the polyhydroxyfunctional branched polyether alkyl radical —Z—R is introduced into the polyhydroxy-functional polysiloxane by an addition reaction of a dendritic polyhydroxy-functional allyl polyether with an Si—H-functional alkylpolysiloxane and wherein the at least one branched dendritic polyhydroxy-functional allyl polyether is prepared by a ring-opening polymerization of the at least one hydroxyoxetane with one or more hydroxy-bearing allylic starter compounds and subsequent addition reaction of water.

42. The polyhydroxy-functional polysiloxane according to claim 35, wherein the at least one branched dendritic polyhydroxy-functional allyl polyether is prepared by a ring-opening polymerization of the at least one hydroxyoxetane with the one or more hydroxy-bearing allylic starter compounds is derived from a compound from the group consisting of 5,5-dihydroxymethyl-1,3-dioxane, 2-methyl-1,3-propanediol, 2-methyl-2-ethyl-1,3-propanediol, 2-ethyl-2-butyl-1,3-propanediol, neopentyl glycol, dimethylolpropane, glycerol, trimethylolethane, trimethylolpropane, diglycerol, di(trimethyl-olethane), di(trimethylolpropane), pentaery-thritol, di(pentaerythritol), anhydroenneaheptitol, sorbitol, and mannitol.

43. The polyhydroxy-functional polysiloxane according to claim 42, characterized in that the one or more hydroxy-bearing allylic starter compound is trimethylolpropane monoallyl ether or glycerol monoallyl ether.

44. The polyhydroxy-functional polysiloxane according to claim 35, wherein the at least one hydroxyoxetane comprises at least one 3-alkyl-3-(hydroxyalkyl)oxetane, 3,3-di(hydroxyalkyl)oxetane, 3-alkyl-3-(hydroxyalkoxy)oxetane, 3-alkyl-3-(hydroxyalkoxyalkyl)oxetane or a dimer, trimer, or polymer of a 3-alkyl-3-(hydroxyalkyl)-oxetane, of a 3,3-di(hydroxyalkyl)oxetane, of a 3-alkyl-3-(hydroxyalkoxy)oxetane, or of a 3-alkyl-3-(hydroxyalkoxyalkyl)oxetane.

45. The polyhydroxy-functional polysiloxane according to claim 44, wherein the at least one hydroxyoxetane is selected from the group consisting of 3-methyl-3-(hydroxymethyl)oxetane, 3-ethyl-3-(hydroxylmethyl)oxetane, and 3,3-di(hydroxymethyl)oxetane (trimethylolpropane oxetane).

46. The polyhydroxy-functional polysiloxane according to claim 35, wherein the at least one branched dendritic polyhydroxy-functional allyl polyether has at least two branching generations.

47. The polyhydroxy-functional polysiloxane according to claim 46, wherein the polydispersity of the at least one branched dendritic polyhydroxy-functional allyl polyether is less than 2.8.

48. The polyhydroxy-functional polysiloxane according to claim 38, wherein at least one free hydroxyl group of the at least one branched dendritic polyhydroxy-functional allyl polyether has been chemically modified.

49. The polyhydroxy-functional polysiloxane according to claim 38, wherein the substituent Z—RK is introduced into the polyhydroxy-functional polysiloxane by an addition reaction of an unbranched allyl polyether and wherein the unbranched allyl polyether is prepared by alkoxylating allyl alcohol or monoallyl ethers having one or more hydroxyl groups with ethylene oxide, propylene oxide, butylene oxide, or styrene oxide.

50. The polyhydroxy-functional polysiloxane according to claim 49, wherein the unbranched polyether radical RK is an ethylene oxide, a propylene oxide, or an ethylene oxide-propylene oxide copolymer of the following formula
RK is —O—[EO]ᵥ—[PO]_{w}—R⁶
with v is 0-70; if v is 0 then w is greater than or equal to 1;
with w is 0-50; if w is 0 then v is greater than or equal to 1; and
R⁶ is an aliphatic, aromatic, or araliphatic compound, which contains optional heteroatoms.

51. The polyhydroxy-functional polysiloxane according to claim 38, wherein the substituent Z—RK is introduced by condensation reaction of corresponding compound HO—Z—RK.

52. The polyhydroxy-functional polysiloxane according to claim 38, wherein A and C are 0, and at least one of the groups R² and R³ is a radical R.

53. The polyhydroxy-functional polysiloxane according to claim 52, wherein exactly one of the groups R² and R³ is a radical R.

54. A process for preparing polyhydroxy-functional polysiloxanes according to claim 35, wherein first at least one of the one or more hydroxy-bearing allylic starter compounds is reacted with at least one hydroxyoxetane and then the allyl polyether or polyethers is or are subjected to addition reaction with the Si—H-functional alkyl polysiloxane.

55. The process for preparing polyhydroxy-functional polysiloxanes according to claim 35, wherein first at least one of the one or more hydroxy-bearing allylic starter compounds is subjected to addition reaction with the Si—H-functional alkyl polysiloxane and then the bound starter compound is reacted with at least one hydroxyoxetane.

56. The process for preparing polyhydroxy-functional polysiloxanes according to claim 35, wherein first at least one of the one or more hydroxy-bearing allylic starter compounds bearing a hydroxyalkyl radical is reacted with at least one hydroxyoxetane and then the hydroxyalkyl polyether or polyethers is or are subjected to condensation reaction with the Si—H-functional alkyl polysiloxane.

57. The process for preparing polyhydroxy-functional polysiloxanes according to claim 35, wherein first at least one of the one or more hydroxy-bearing allylic starter compounds bearing a hydroxyalkyl radical is subjected to condensation reaction with the Si—H-functional alkyl polysiloxane and then the bound starter compound is reacted with at least one hydroxyoxetane.

58. The process for preparing polyhydroxy-functional polysiloxanes according to claim 54, wherein the free hydroxyl groups of the polyethers or of the hydroxyalkyl polyethers are chemically modified before or after the hydrosilylation or condensation reaction with the Si—H-functional polysiloxane.

59. The process for preparing polyhydroxy-functional polysiloxanes according to claim 54, wherein the subsequently unbranched allyl polyethers or allyl polyesters are subjected to an addition reaction with the Si—H-functional polysiloxane.

60. The process for preparing polyhydroxy-functional polysiloxanes according to claim 54, wherein the unbranched allyl polyethers or allyl polyesters in a mixture with branched allyl polyethers are subjected to an addition reaction with the Si—H-functional polysiloxane.

61. The process for preparing polyhydroxy-functional polysiloxanes according to claim 54, wherein the subsequently unbranched hydroxyalkyl polyethers are subjected to a condensation reaction with the Si—H-functional polysiloxane.

62. The process for preparing polyhydroxy-functional polysiloxanes according to claim 54, wherein the unbranched hydroxyalkyl polyethers in a mixture with branched hydroxyalkyl polyethers are subjected to condensation reaction with the Si—H-functional polysiloxane.

63. The use of a polyhydroxy-functional polysiloxane according to claim 35 as an additive in coating compositions, polymeric moulding compounds, or thermoplastics.

64. A coating composition, polymeric moulding compound, or thermoplastic comprising a polyhydroxy-functional polysiloxane according to claim 35.

65. A coating composition containing 0.1%-10% by weight of a polyhydroxy-functional polysiloxane according to claim 35.

66. A polymeric moulding compound containing 0.1%-10% by weight of a polyhydroxy-functional polysiloxane according to claim 35.

67. A thermoplastic containing 0.1%-5% by weight of a polyhydroxy-functional polysiloxane according to claim 35.
